(19) United States
(12) Patent Application Publication
(10) Pub. No.: US 2021/0204725 A1
(43) Pub. Date: Jul. 8, 2021

(54) Adhesive Surface Divider

(71) Applicant: William Marton Jojarth, Palo Alto, CA (US)

(72) Inventor: William Marton Jojarth, Palo Alto, CA (US)

(21) Appl. No.: 17/249,993

(22) Filed: Mar. 21, 2021

(51) Int. Cl. A47G 5/00

(52) U.S. Cl. CPC A47G 5/00

(57) ABSTRACT

An adhesive surface organizer consists of an adhesive device (such as suction cups or adhesive tape) attached to a solid divider wall material. Once pushed onto a flat non-porous surface (such as a drawer, a countertop or the floor), this product is used to separate and organize different types of smaller objects that are placed on that same flat surface and that may otherwise intermingle. Several adhesive surface organizers may be placed on the same surface to create organizational units that are enclosed on all sides, or to form rows and a grid creating multiple organizational units. For example, one may place four adhesive surface organizers to create a square shape. The user may store different smaller items in these various organizational units. The adhesive surface organizer can be placed on both vertical and horizontal surfaces.

### BACKGROUND

The present invention relates to an organizer for organizing items that adheres to a flat surface. It helps organize items in an organized fashion such as in a row or a grid. Installed on a flat surface, the adhesive surface organizer creates separate spaces, which can be used to sort various smaller items.

### SUMMARY OF INVENTION

The surface organizer consists of a divider wall (FIG. 1/Marker 1) and an adhesion device (FIG. 1/Marker 2), and is installed on a horizontal or vertical flat surface (FIG. 1. Marker 5) such as a hardwood floor or window glass.

Adhesion may be achieved through methods such as suction cups or sticky substances, which are reusable and not damage the surface.

Attaching the adhesive surface divider to the flat surface creates a wall in the location chosen. This makes it so that the small objects that the user may place on either side of the adhesive surface organizer cannot pass from one separate organizational space to the other.

This product has many applications where the user stores multiple types of items onto a flat surface, but wishes to keep them separated. Some people have attempted to solve this by using bins. These are very difficult to store and cannot be expanded or made smaller.

### DRAWINGS

FIG. 1 shows the side view of the adhesive surface divider. Marker 1 shows the divider wall made from a solid material. Marker 2 shows the adhesive device. This can be a suction cup or an adhesive. The size and shape depends on the adhesive device used. In the case that the adhesive device is attached to the bottom of the divider wall using screws, clips or other mechanical means, Marker 3 shows that screw or other mechanical means. Marker 5 shows the flat surface, onto which the adhesive divider wall is installed. Marker 4 shows that the divider wall may be shaped so that the gap between the flat surface and the divider wall is minimized, even when the adhesive device protrudes from the bottom of the divider wall.

FIG. 2 shows the cross section of the adhesive surface divider.

FIG. 3 shows the top view of the divider. Marker 2 shows the adhesive device. If the adhesive device is wider than the divider wall (for example a 2 inch suction cup attached to a ½ inch thick divider wall), then Marker 6 shows the part of the adhesive device that is protruding beyond the divider wall. Marker 7 shows the thickness of the divider wall. Marker 8 marks the distance between the adhesive and the edge of the divider wall. If the adhesive device is wider than the divider wall and if the user intends to make a grid or a rectangular shape from multiple adhesive organizers, distance shown by Market 7 should not be larger than the distance shown by Marker 8, in order to ensure that two dividers can connect seamlessly.

FIG. 4 shows a surface (Marker 5) with seven different sizes of building blocks. The seven types are intermingled, which makes playing difficult.

FIG. 5 shows the same blocks on the same surface with adhesive surface organizers separating the spaces allocated for each type of building block. In this figure, twelve surface organizers are placed on the flat surface to create seven organizational units. Marker 9 shows an area where the adhesive surface organizers are placed in such a way that the organizational space is surrounded by a wall on all four sides.

### DETAILED DESCRIPTION

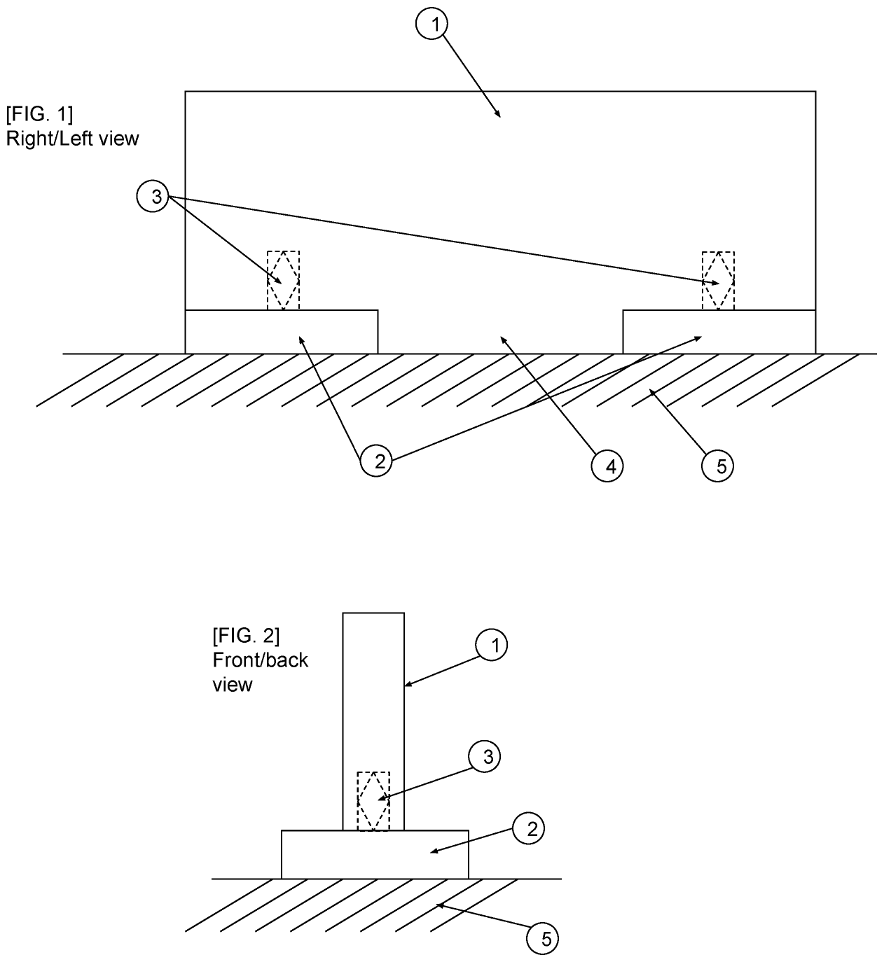

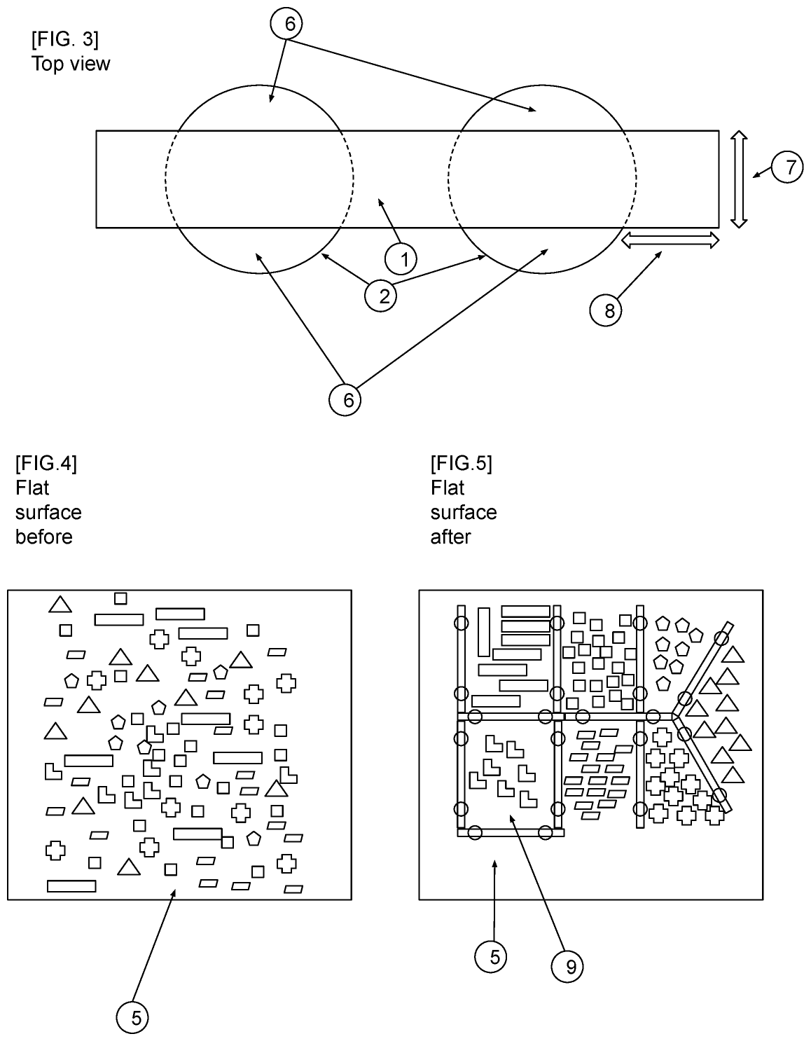

The surface organizer consists of a divider wall (FIG. 1/Marker 1) and an adhesion device (FIG. 1/Marker 2), and is installed on a flat surface (FIG. 1/Marker 5).

The divider wall can be made from plastic, metal, wood, glass, or any other solid material and should have sufficient thickness and stiffness to be stable and allow for the attachment of the adhesion device on its bottom.

The adhesive device should be attached to the solid material in such a way that it does not separate from it when pulled by hand, in order to allow for a more consistent location once the surface organizer is installed. The adhesive device needs to be able to adhere to flat surfaces. Adhesion may be achieved through methods such as suction cups or sticky substances. The method of adhesion should be reusable and not damage the surface. This allows for the product to move easily when the user wants it to.

The adhesive surface organizer is installed on a non-porous flat surface. The flat surface can be hardwood flooring, painted wood, tiles, polished stone, melamine, vinyl, glass, or similar. The flat surface can be horizontal (such as a floor or kitchen counter), vertical (such as a door or a window) or tilted (such as the wall of a bathtub).

Attaching the adhesive surface divider to the flat surface creates a wall in the location chosen. The size and shape of the wall is determined by the size and shape of the divider wall. The bottom of the divider wall material is cut in a shape (FIG. 1/Marker 4) so that when the adhesive device is adhering to the flat surface, the gap between the flat surface and the adhesive surface organizer is minimized. This makes it so that the small objects that the user may place on either side of the adhesive surface organizer cannot pass beneath it.

This product has many applications. One such application is while playing with building blocks of different types. To aid the playing with these building blocks some users separate their blocks into multiple piles, for example by size of shape. During the process of playing, building blocks from multiple piles can intermingle and make the playing very difficult (FIG. 4). Some people have attempted to solve this by using bins. These are very difficult to store and cannot be expanded or made smaller. This invention is used by installing one or more adhesive surface organizers on the playing surface (the floor, or a table) (FIG. 5). When storing building blocks, the user can place the dividers in a square shape with 1 divider per side. This replicates a bin, but uses less space and can easily be resized by adding more dividers to one or both dimensions. Other applications include the organization of items in a drawer, on a shelf, a table, a counter.

If needed, the invention can also be used to organize items on vertical surfaces. For example, one may apply it to a vertical surface such as a window to make a shelf, or a shelf with multiple compartments.

1. An adhesive surface organizer that self-adheres to a flat surface, preventing objects from passing below or over it and from intermingling

2. An adhesive surface organizer that can be connected with other adhesive surface organizers to form a line or grid without allowing objects from passing between them

3. A surface organizer that is removable from and repositionable on a flat surface without damaging the flat surface or leaving a mark on it
